(19) United States
(12) Patent Application Publication
(10) Pub. No.: US 2025/0350015 A1
(43) Pub. Date: Nov. 13, 2025

(54) Antenna packaging structure

(71) Applicant: Shenzhen Antop Technology Co., Ltd., Shenzhen (CN)

(72) Inventor: Ruidian YANG, Shenzhen (CN)

(21) Appl. No.: 18/913,583

(22) Filed: Oct. 11, 2024

(30) Foreign Application Priority Data
May 9, 2024 (CN) 202420998849.1

(51) Int. Cl. H01Q 1/08; H01Q 1/42; H01Q 5/47; H01Q 13/18

(52) U.S. Cl. CPC H01Q 1/08; H01Q 1/427; H01Q 5/47; H01Q 13/18

(57) ABSTRACT

An antenna packaging structure includes a packaging container and an antenna contained within the packaging container. The antenna includes a flexible substrate, an antenna element disposed on the flexible substrate, a feeder structure connected to the antenna element, and a coaxial cable connected to the feeder structure. The flexible substrate inside the packaging container is in a folded state with a folding line thereof avoiding the feeder structure, and an elastic space with a teardrop-shaped cross-section is formed between the flexible substrate on both sides of the folding line in each folding. The antenna element is folded along with the flexible substrate and maintains electrical properties after being unfolded. The coaxial cable is disposed in the elastic space or between the flexible substrate and the packaging container.

### CROSS REFERENCE TO RELATED APPLICATIONS

The present application claims priority from Chinese Application No. CN 202420998849.1 filed on May 9, 2024, all of which are hereby incorporated herein by reference.

### TECHNICAL FIELD

The present disclosure relates to the field of antenna technology, and specifically relates to an antenna packaging structure.

### BACKGROUND TECHNOLOGY

In the field of wireless signal reception, a flat panel antenna, as an efficient and widely used radiating unit, is widely used in the fields of television, communication, radio and satellite reception. Flat panel antennas have gained a large share of the market because of simplified structure, light weight, excellent radiation performance, low-profile characteristics and easy installation. With increasing development and popularization of wireless signal reception technology, demands for flat panel antennas are also increasing dramatically. However, traditional flat panel antennas usually have large volume, causing serious problems of packaging and transportation of flat panel antennas, which is required to be urgently resolved.

Existing flat panel antennas are made of rigid materials or small-amplitude bending materials, resulting in large physical dimensions, especially in the unfolded state of the antenna panel, it tends to occupy a large space. Due to large area of the flat panel antenna, such a large-sized flat panel antenna needs to be packaged in a larger box or packaging structure, which not only increases consumption of packaging materials, but also makes the entire packaging structure bulky and unfavorable for handling and storage.

In logistics transportation, large-sized packaging structure occupies more space for transportation, and space cost is an important expense, especially in long-distance transportation or air transportation, relatively large packaging volume will significantly increase transportation cost, which leads to reduction of transportation efficiency and increase of transportation cost. In addition, large dimension of packaging structure also increases risk of breakage or deformation during transportation, which further affects quality and performance of the antenna.

In view of the above problems, large flat antennas in the prior art have inadequacy in terms of transportation and storage. Therefore, there is an urgent need for an improved antenna design capable of reducing transportation and storage costs by changing its physical form.

### SUMMARY

The present invention seeks to provide a solution to the before-mentioned problems and thus provides an antenna packaging structure that can significantly reduce space required, thereby effectively reducing transportation cost.

The antenna packaging structure of the present disclosure includes a packaging container and an antenna contained in the packaging container. The antenna includes a flexible substrate, an antenna element disposed on the flexible substrate, a feeder structure connected to the antenna element and a coaxial cable connected to the feeder structure. In the present disclosure, the flexible substrate inside the packaging container is in a folded state with a folding line thereof avoiding the feeder structure, and an elastic space with a teardrop-shaped cross-section is formed between the flexible substrate on both sides of the folding line in each folding, the antenna element is folded along with the flexible substrate and maintains electrical properties after being unfolded, and the coaxial cable is disposed within the elastic space or between the flexible substrate and the packaging container.

With the antenna folded and accommodated in the packaging container, safety and stability of the antenna can be effectively ensured during transportation and storage, thus reducing risk of damage caused by external forces or environmental factors. It can prevent the antenna element folded together with the flexible substrate from being over-folded and ensures electrical performance thereof free from influence, by forming an elastic space with a teardrop-shaped cross-section between the flexible substrate on both sides of the folding line in each folding. Therefore, the design of the packaging structure is further compressed compared with the existing flat antenna packaging structure, thereby improving efficiency of transportation and storage. Due to flexible characteristics of the flexible substrate, the antenna can be restored to its original shape and state after being unfolded, ensuring performance and usage of the antenna. In such package configuration, for normal use it only requires to remove the antenna from the packaging container and unfold it, without any complicated operation or adjustment. Such design thus is applicable to antennas of various dimensions and shapes, which thus has wide applicability and flexibility.

In the present disclosure, the dimension of a cavity of the packaging container matches the dimension of the flexible substrate after being folded.

The cavity of the packaging container in the present disclosure is designed to match the dimension of the antenna after being folded, so that a close fit between the packaging and the antenna can be achieved. This design not only ensures that the antenna can be completely stowed inside the packaging container in the folded state, but also improves space utilization of the packaging container, reduces unnecessary waste of packaging materials, and maximizes reduction of packaging volume. In addition, this precise dimension matching can effectively prevent the antenna from moving or shaking in the packaging container, and also ensure stability of the antenna in the packaging container, strengthen protection effect of the packaging on the antenna, and reduce risk of damage caused by external impact during transportation.

The packaging container can be a packaging box, or a packaging bag, or other forms of packaging containers formed by blister packaging and so on. Specifically, the packaging container can be designed as hollow polyhedrons such as prisms, frustums of pyramids, pyramids, etc., or as hollow bodies of revolution such as cylinders, frustums of cones, cones, spheres, etc. Among them, prismatic or cylindrical packaging container is more adapted to the shape of the antenna after being folded, and also more closely fit the shape of the cavity, which can not only further enhance space utilization of the packaging container and reduce unnecessary waste of packaging materials, but also more convenient for stacking and handling, which is conducive to improving efficiency of logistics.

Furthermore, the flexible substrate has a first direction and a second direction perpendicular to each other, the flexible substrate in the present disclosure is folded at least two times in the first direction to form an elongated structure, and edges of two sides of the elongated structure parallel to the second direction are respectively close to edges of two sides of the feeder structure.

By folding the flexible substrate multiple times in the first direction, the antenna that originally occupies a large space is effectively compressed into an elongated structure, thereby significantly reducing volume required for packaging, so that the packaging container and its inner cavity can have a smaller dimension, and the entire antenna packaging structure thus is more compact. This not only reduces transportation cost, but also improves efficiency of storage space utilization, especially evident in the scenario of limited space. With making the two edges of the elongated structure parallel to the second direction close to the two edges of the feeder structure respectively, folding compactness of the flexible substrate is maximized and a stable structure is formed, which not only helps to maintain overall shape and stability of the antenna, but also reduces deformation or damage of the structure due to vibration or impact, thus improving stability and reliability of the antenna. Folded into a long structure, it can be packaged in a long packaging container, which makes the antenna present a neat and orderly appearance after packaging, and enhances overall texture of the product.

The feeder structure in the present disclosure may be disposed in the middle of the flexible substrate in the first direction, dividing the flexible substrate into a left substrate and a right substrate, the left substrate being folded to the right along the edge of the feeder structure, and the right substrate, together with the left substrate covering thereon, continuing to be folded to the right multiple times along the edge of the feeder structure to form the elongated structure. Alternatively, the feeder structure is disposed in the middle of the flexible substrate in the first direction, dividing the flexible substrate into a left substrate and a right substrate, the right substrate being folded to the left along the edge of the feeder structure, and the left substrate, together with the right substrate covering thereon, continuing to be folded to the left multiple times along the edge of the feeder structure to form the elongated structure.

For an antenna in which the feed structure is disposed in the middle of the flexible substrate in the first direction, the flexible substrate is naturally divided into a left substrate and a right substrate. By folding the flexible substrate on one side of the feeder structure to the other side along an edge of the feeder structure, and then continuing to fold the flexible substrate along the edge of the feeder structure in the first direction multiple times until it cannot be folded any further, the elongated structure with the edges of the two sides close to the edges of the two sides of the feeder structure is formed. This orderly folding method not only ensures that the dimensions of the folded elongated structure will not fluctuate greatly, and can be completely stored in the packaging container, but also helps to standardize packaging process and improve packaging efficiency. Among them, after the flexible substrate on one side of the feeder structure is folded along the edge of the feeder structure to the other side, followed by a process of continuing to be folded in the first direction for multiple times in the way of the wallet-folding, in such way the elastic space formed in each folding can be made full use, which is not only able to further improve folding compactness of the flexible substrate, but also able to avoid the elastic space from being excessively squeezed by the action of the external force, and thus avoid electrical performance of the antenna element from being affected. The coaxial cable in such design can be disposed between the elongated structure and the packaging container, or can be disposed in the elastic space. The latter can fully utilize the elastic space and hold up the elastic space to avoid the elastic space from being excessively squeezed by an external force, thereby avoiding the electrical performance of the antenna element from being affected. Specifically, it can be disposed in the elastic space formed by the first folding, or can be disposed in the elastic space formed by the second folding.

In another folding method of the present disclosure, the feeder structure is disposed in the middle of the flexible substrate in the first direction, dividing the flexible substrate into a left substrate and a right substrate, the left substrate being folded to the right along the edge of one side of the feeder structure, and the right substrate being folded to the left multiple times together with the left substrate covering thereon, and finally being folded along the edge of the other side of the feeder structure to form the elongated structure. Alternatively, the feeder structure is disposed in the middle of the flexible substrate in the first direction, dividing the flexible substrate into a left substrate and a right substrate, the right substrate being folded to the left along the edge of one side of the feeder structure, the left substrate being folded to the right multiple times together with the right substrate covering thereon, and finally being folded along the edge of the other side of the feeder structure to form the elongated structure.

In this way, the flexible substrate on one side of the feeder structure is first folded along the edge of the feeder structure to the other side, the flexible substrate on the other side of the feeder structure is folded toward the feeder structure a number of times in the aforementioned folded state until it cannot be continued to be folded, and flexible substrate is folded along the edge of the other side of the feeder structure in the last folding. This folding method ensures that the two edges of the final elongated structure are close to the two edges of the feeder structure, and ensures that the elongated structure can be completely stored in the packaging container. In addition to the first and last folding along the edges of the feeder structure, position of the folding line can be adjusted according to the actual situation in the intermediate folding between the first and last folding, in order to maximize compactness of the final elongated structure, and make the folding method more flexible. The coaxial cable in this way can be disposed between the elongated structure and the packaging container, or can be disposed in the elastic space. The latter allows the elastic space to be fully utilized and propped up to avoid the elastic space from being excessively squeezed by external forces, thereby preventing electrical performance of the antenna element from being affected. It is preferable to be disposed in the elastic space formed by the last folding.

Further, the dimension of the elongated structure in the second direction is 3 to 15 times the dimension thereof in the first direction, and the dimension of the elongated structure in the first direction is 1.5 to 8 cm.

By controlling the dimension of the elongated structure in the second direction to be 3 to 15 times the dimension thereof in the first direction, it is ensured that the flexible substrate can be folded as short and compact as possible. On the one hand, because the dimension in the second direction needs to be controlled within a certain ratio, the producer will, as far as possible, determine the first direction and the second direction in the packaging process in a way that the dimension in the second direction after being folded is relatively small; on the other hand, because the dimension in the first direction is much smaller than that in the second direction, the antenna will be able to form a compact elongated structure after being folded, which will significantly reduce the dimension in the first direction. The above aspects both will significantly reduce the space occupied by the antenna inside the packaging container, so that the packaging container and its inner cavity dimensions can be designed to be smaller both in the first direction and the second direction, which is very favorable for saving space for transportation and storage, as well as reducing the cost of packaging. In addition, folding the antenna compactly can also improve the impact strength of the antenna during transportation and storage, which is more conducive to avoiding damage or deformation due to external force during transportation and storage, and is conducive to protecting the flexible substrate and the antenna element of the antenna.

By limiting the dimension in the first direction to a range of 1.5 to 8 cm, the antenna is made to have a moderate and stable dimension after being folded into the elongated structure. Such a dimension design is neither too large to cause the packaging container to be too bulky, nor too small to affect the performance or structural integrity of the antenna. This moderate dimension design helps to realize the standardization and unification of the packaging container, which is convenient for production, transportation and management. During the folding process, the moderate dimension in the first direction ensures a stable relative position between the antenna components and avoids displacement or deformation due to vibration or shock during transportation. This helps protect structural integrity of the antenna and ensures that it will work properly after being unfolded. After completing the folding, the moderate dimension in the first direction also makes the packaging container moderate in dimension, which is convenient for sales transportation and storage, as well as convenient for users to carry and move. For users, whether working outdoors or using indoors, it can be easily carried to meet their communication needs anytime and anywhere.

In an advantageous case of the present disclosure, the flexible substrate has a first direction and a second direction perpendicular to each other, it is folded a number of times in the first direction and then folded a number of times in the second direction to form a wallet-like structure.

By folding in two mutually perpendicular directions, the antenna can be compressed into a more compact form, significantly reducing the volume occupied in the package, which is conducive to reducing the dimension of the packaging container and its inner cavity, and making the entire antenna packaging structure more compact and lightweight. This not only reduces the cost of packaging, but also makes transportation and storage more convenient, especially suitable for scenes with limited space. In the folding process, whether it is folded in the first direction or folded in the second direction, if it is folded at least two times in that direction, it is preferred to be folded by means of wallet-folding, which makes full use of the elastic space formed by each folding and makes the folded antenna more compact. After being folded, the antenna as a whole presents a wallet-like structure, which can be packaged in a flat packaging container, so that the antenna presents a neat and organized appearance after packaging, which enhances the overall texture of the product. The coaxial cable can be disposed between the wallet-like structure and the packaging container, or can be disposed in the elastic space. The latter can fully utilize the elastic space and hold up the elastic space to avoid the elastic space from being excessively squeezed by an external force, thereby avoiding the electrical performance of the antenna element from being affected. Specifically, it can be disposed in the elastic space formed by folding in the second direction.

Particularly, the feeder structure is disposed in the middle of the flexible substrate in the first direction, the flexible substrate is folded even number of times in the first direction in this case; and/or, the feeder structure is disposed in the middle of the flexible substrate in the second direction, the flexible substrate is folded even number of times in the second direction.

By folding an even number of times in the first direction and/or the second direction, the folded lines can be evenly distributed on both sides of the feeder structure, which makes the folded lines avoiding the feeder structure, thus avoiding the need to repeatedly adjust position of the folded line during folding process to improve the folding efficiency. Even number of folding also ensures that the flexible substrate can form a symmetrical structure after being folded, thus making the antenna neater and more orderly in appearance. In addition, this folding method also effectively reduces the space occupied by the antenna in the package and improves space utilization.

In addition, the wallet-like structure has a third direction perpendicular to the first direction and the second direction, the wallet-like structure has a dimension of 2 to 6 cm in the third direction and a dimension of 5 to 15 cm in the first direction and/or the second direction.

By limiting the dimensions in the three mutually perpendicular directions to a specific range, the antenna is made to have a moderate and stable dimension when folded into the wallet-like structure. Such dimension design is neither too large to make the packaging container too bulky, nor too small to affect the performance or structural integrity of the antenna. This moderate dimension design helps to realize the standardization and unification of the packaging container, which is convenient for production, transportation and management. During the folding process, the moderate dimension in the third direction ensures that the elastic space is not overly compressed, which helps protect structural integrity of the antenna and ensures that it will function properly after being unfolded. After the folding is completed, the moderate dimension in the third direction also allows the packaging container of the right dimension, which is convenient for sales and transportation and storage, as well as convenient for users to carry and move. For users, whether working outdoors or using indoors, it can be easily carried to meet their communication needs anytime and anywhere.

According to the present disclosure, the flexible substrate may be a sheet-like structure made of thermoplastic polyurethane elastomer (TPU), polyimide (PI) or polyester (PET, etc.), the antenna element is a metal conductive network layer printed on the flexible substrate, and the linewidth of each line in the antenna element is 3 to 12 mm.

The use of thermoplastic polyurethane elastomer (TPU), polyimide (PI) or polyester (PET, etc.) as the material for the flexible substrate gives the antenna excellent flexibility and crease resistance. This material is not only lightweight, but also maintains its structural integrity and is not easily damaged when subjected to external forces. This allows the antenna to maintain its original functionality and stability in scenarios where bending is required.

Designing the antenna element as a metal conductive network layer printed on a flexible substrate not only simplifies manufacturing process of the antenna and reduces production cost, but also improves integration of the antenna, precision and reliability of the antenna element, as well as strengthens the bonding between the antenna element and the flexible substrate to avoid risk of damage caused by folding. In addition, the metal conductive network layer has excellent electrical conductivity, ensuring high efficiency and stability of the antenna element in the signal transmission process.

With fully taking into account the balance between performance of the antenna and difficulty of manufacturing, the linewidth of each line in the antenna element is set at 3 to 12 mm. The relatively wide linewidth is conducive to reducing resistance and improving radiation efficiency of the antenna, and, this linewidth range is also within capability of the existing manufacturing technology, which thus can realize higher manufacturing precision and consistency.

The antenna in the present disclosure is folded and accommodated in the packaging container, it can effectively protect safety and stability of the antenna during transportation and storage, reduce risk of damage due to external forces or environmental factors, compress the space occupied by the antenna packaging structure, and improve efficiency of transportation and storage. The flexible substrate on both sides of the folding line forms an elastic space with a teardrop-shaped cross-section, which can avoid excessive folding of the antenna element folded with the flexible substrate to ensure good electrical performance without any influence.

### BRIEF DESCRIPTION OF THE DRAWINGS

The accompanying drawings are for exemplary illustration only and are not to be construed as a limitation of the present disclosure; in order to better illustrate the present disclosure, certain parts of the accompanying drawings will be omitted, enlarged or reduced, and do not represent the dimensions of the actual product; for those skilled in the art, it is understandable that certain well-known structures and their descriptions in the accompanying drawings may be omitted.

In the drawings:

FIG. 1 is a perspective view of an antenna packaging structure according to an embodiment of the present disclosure;

FIG. 2 is a perspective view of another possible antenna packaging structure;

FIG. 3 is an unfolded view of the antenna with the feeder structure in the middle;

FIG. 4 is an unfolded view of the antenna with the feeder structure at the edge;

FIG. 5 is a perspective view of the antenna in folded state according to an embodiment of the present disclosure;

FIG. 6 is a side view of FIG. 5;

FIG. 7 is a perspective view of the antenna in folded state according to an alternative embodiment of the present disclosure;

FIG. 8 is a side view of FIG. 7;

FIG. 9 is a perspective view of the antenna in folded state according to another embodiment of the present disclosure, and

FIG. 10 is a schematic view showing a hollow cylindrical packaging box.

Reference signs: 100 packaging container, 200 antenna, 210 flexible substrate, 220 antenna element, 230 feeder structure, 240 coaxial cable, 201 elastic space, I first direction, and II second direction.

### DETAILED DESCRIPTION OF THE PREFERRED EMBODIMENTS

In order to enable those skilled in the art to better understand the present disclosure, the following is a further detailed description of the present disclosure in connection with specific embodiments.

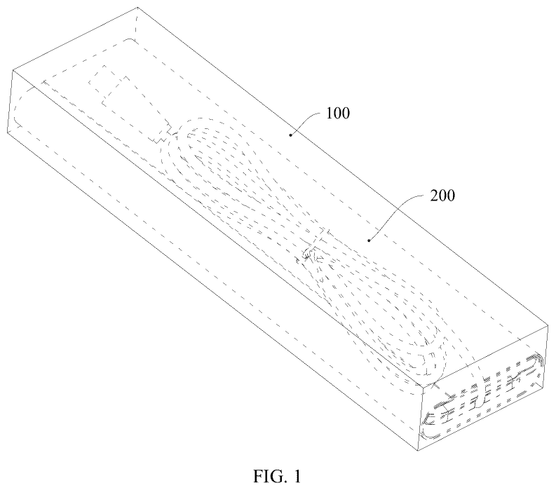

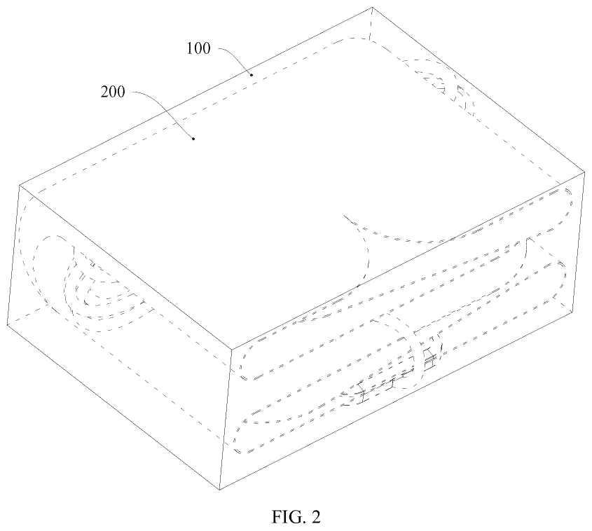

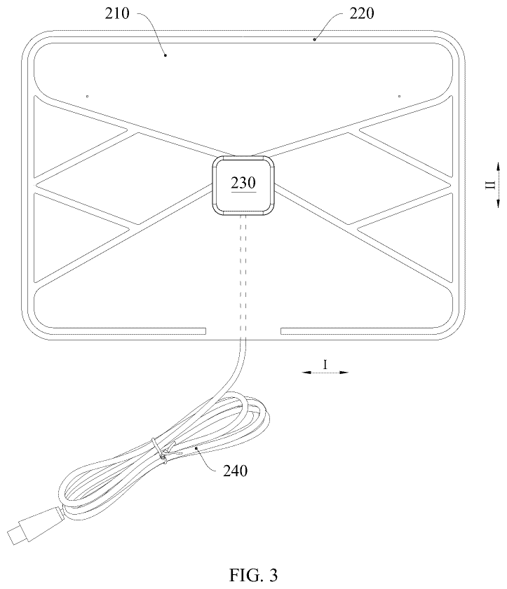

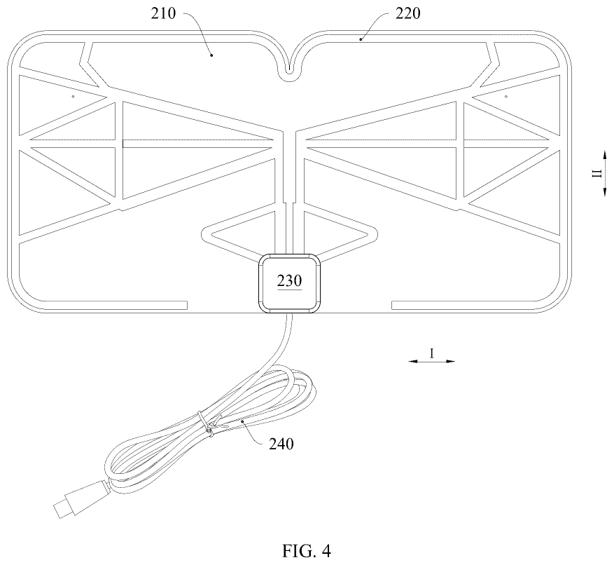

FIGS. 1 to 2 illustrate possible antenna packaging structures according to an embodiment of the present disclosure. Each structure includes a packaging container 100 and an antenna 200 contained within the packaging container 100. As shown in FIGS. 3 to 4, the antenna 200 includes a flexible substrate 210, an antenna element 220 disposed on the flexible substrate 210, a feeder structure 230 connected to the antenna element 220, and a coaxial cable 240 connected to the feeder structure 230.

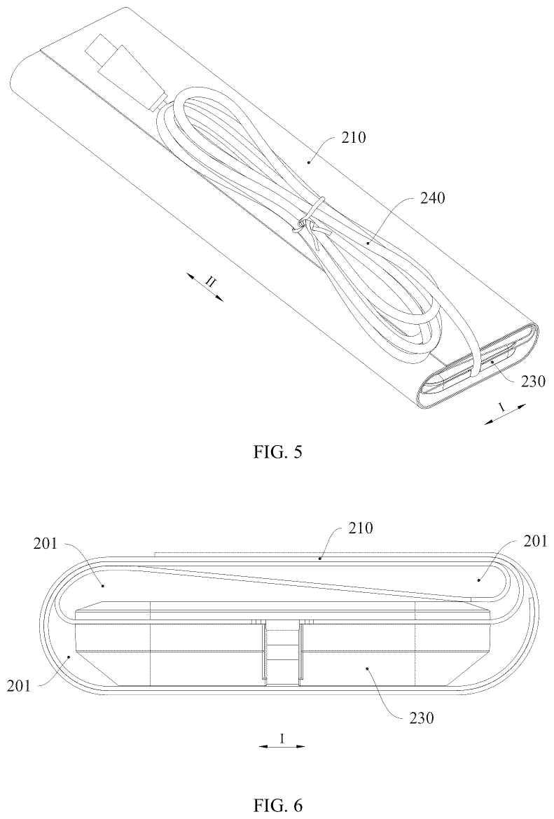

Referring back to FIGS. 1 to 2, the flexible substrate 210 is in a folded state inside the packaging container 100, with its folding line avoids the feeder structure 230, and an elastic space 201 with a teardrop-shaped cross-section is formed between the flexible substrate 210 on both sides of the folding line after each folding, clearly shown in FIGS. 5 to 9. The antenna element 220 is folded with the flexible substrate 210, and after being unfolded it still maintains electrical properties. The coaxial cable 240 is disposed within the elastic space 201 or between the flexible substrate 210 and the packaging container 100.

With the antenna 200 folded and accommodated in the packaging container 100, it can effectively ensure safety and stability of the antenna 200 during transportation and storage, with less risk of damage due to external forces or environmental factors. The elastic space 201 with a teardrop-shaped cross-section formed between the flexible substrate 210 on both sides of the folding line can avoid excessive folding of the antenna element 220 that is folded together with the flexible substrate 210 and thus ensure good electrical performance free from influence. Therefore, design of such packaging structure achieves further compressed occupied space relative to the existing packaging structure of the flat panel antennas, and thus improves efficiency of transportation and storage. Due to flexible characteristics of the flexible substrate 210, the antenna 200 can be restored to its original shape and state after being unfolded, ensuring performance and normal use of the antenna 200. In such package configuration, for normal use it only requires to remove the antenna 200 from the packaging container 100 and unfold it, without any complicated operation or adjustment. In addition, such design is applicable to antennas 200 of various dimensions and shapes, which thus has wide applicability and flexibility.

The packaging container 100 may be a packaging box, a packaging bag, or other forms of packaging containers formed by blister packaging and the like. The structure thereof can be designed as hollow polyhedrons such as prisms (as shown in FIGS. 1 to 2), frustums of pyramids, pyramids, etc., or as hollow bodies of revolution such as cylinders (as shown in FIG. 10), frustums of cones, cones, spheres, etc. However, the packaging container 100 is preferably designed as a hollow prism or cylinder, which facilitates stacking and handling and in turn improves logistics efficiency. Moreover, prismatic or cylindrical packaging container 100 better matches the folded shape of the antenna 200, as well as the shape of the cavity, which can further improve space utilization of the packaging container 100 and reduce unnecessary waste of packaging materials. Regardless of the structure, dimension of the cavity of the packaging container 100 matches dimension of the flexible substrate 210 after folded, so that a close fit between the packaging and the antenna product can achieve. Such design not only ensures that the antenna 200 can be completely stowed in the packaging container 100 in the folded state, but also improves the space utilization rate of the packaging container 100, thus reducing unnecessary waste of packaging materials and maximizing reduction of packaging volume. In addition, this precise dimension matching can effectively prevent the antenna 200 from moving or shaking inside the packaging container 100 during transportation and ensure stability of the antenna 200 inside the packaging container 100, thereby strengthening protective effect of the packaging on the antenna 200 and reducing risk of damage due to external impact during transportation.

The antenna 200 has a first direction (as indicated by arrow I) and a second direction (as indicated by arrow II) perpendicular to each other, the flexible substrate 210 can be folded at least two times in the first direction, as shown in FIGS. 5 to 8, so that the antenna 200 which originally occupies a large space is effectively compressed into an elongated structure, thereby substantially reducing volume required for packaging, so that the packaging container 100 and its inner cavity can have much smaller dimensions, and the entire volume of the antenna 200 packaging structure is more compact. This not only reduces transportation cost, but also improves utilization efficiency of the storage space, which is particularly advantageous in the scenario of limited space. In addition, the edges at two sides of the elongated structure parallel to the second direction can be respectively close to the edges at two sides of the feeder structure 230, maximizing compactness of the folded flexible substrate 210 and forming a stable structure, which not only helps to maintain the overall shape and stability of the antenna 200, but also reduces deformation or damage to the structure due to vibration or impact, and improves the stability and reliability of the antenna 200. In such case, the antenna 200 folded can be packaged in an elongated packaging container 100, which presents a neat and organized appearance of the antenna 200 after packaged, and thus improves the overall texture of the antenna product.

With reference back to FIGS. 3 to 4, the first direction refers to the left-right direction, in which the feeder structure 230 is disposed in the middle of the flexible substrate 210, naturally dividing the flexible substrate 210 into a left substrate and a right substrate. FIGS. 5 to 6 show how the antenna 200 in such configuration is folded into the elongated structure. The left (right) substrate is folded to the right (left) along the edge of the feeder structure 230, and the right (left) substrate, together with the left (right) substrate covering thereon, is continued to be folded to the right (left) several times subsequently along the edges of the feeder structure 230. This orderly folding way not only ensures that there will be no major fluctuation in the dimensions of the elongated structure formed by folding, the elongated structure thus can be completely stowed in the packaging container 100, but also facilitates standardization of the packaging process and improves packaging efficiency. Followed the first folding, the antenna 200 continuing to be folded to the right (left) several times means that the folding process is carried out in wallet-folding manner, so as to fully utilize the elastic space 201 formed by each folding, which can not only further improve compactness of the folded flexible substrate 210, but also avoid the elastic space 201 from being excessively squeezed by the action of the external force and thus avoid negative influence on electrical performance of the antenna element 220. It is to be noted that the number of times folded herein in accordance with the wallet-folding method is not limited to three times, but may also be more times. The coaxial cable 240 may be disposed between the elongated structure and the packaging container 100, or may be disposed in the elastic space 201. The latter can fully utilize the elastic space 201 and hold up the elastic space 201 to avoid the elastic space 201 from being overly squeezed by an external force, thereby avoiding the electrical performance of the antenna element 220 from being affected. Specifically, the coaxial cable 240 can be disposed in the elastic space 201 formed in the first folding, and can also be disposed in the elastic space 201 formed in the second folding.

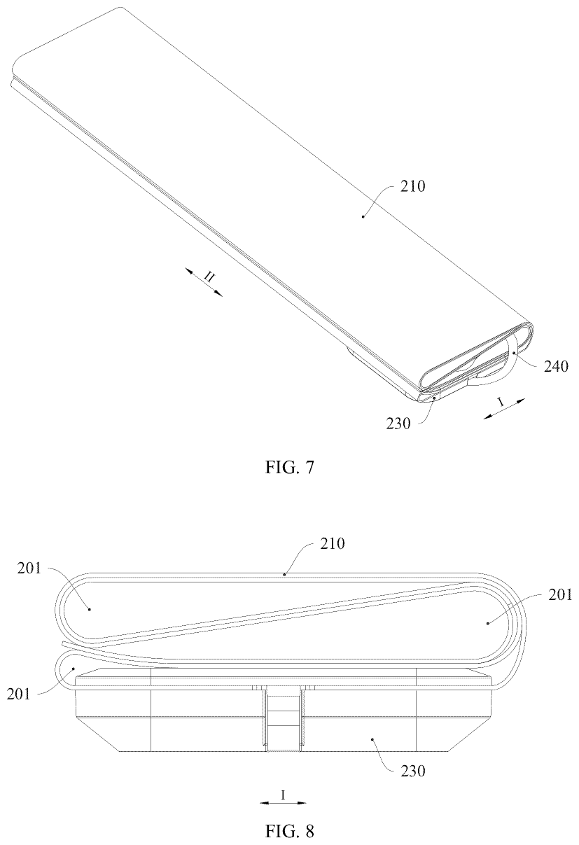

FIGS. 7 to 8 show another way to fold the antenna 200. In this way, the left (right) substrate is folded to the right (left) along the edge of one side of the feeder structure 230, the right (left) substrate is folded to the left (right) several times together with the left (right) substrate covering thereon, and finally folded along the edge of the other side of the feeder structure 230 at the last time. This folding method ensures that the two edges of the resulting elongated structure are close to the two edges of the feeder structure 230, respectively, and thus ensuring that the elongated structure can be fully stowed inside the packaging container 100. Except for the first and the last folding in which it is required to fold along the edges of the feeder structure 230, position of the folding line can be adjusted in the intermediate folding according to the actual situation, so as to maximize compactness of the ultimately obtained elongated structure. This folding method is thus more flexible. The coaxial cable 240 may be disposed between the elongated structure and the packaging container 100, or may be disposed in the elastic space 201. The latter can fully utilize the elastic space 201 and hold up the elastic space 201 to avoid the elastic space 201 from being overly squeezed by external forces, thereby avoiding the electrical performance of the antenna element 220 from being affected. Preferably, the coaxial cable 240 is disposed in the elastic space 201 formed by the last folding.

The dimension of the elongated structure in the second direction is preferably 3 to 15 times the dimension thereof in the first direction, which ensures the flexible substrate 210 to be folded as short and compact as possible. On the one hand, since the dimension in the second direction needs to be controlled within a certain ratio, the producer will, as far as possible, determine the first direction and the second direction in the packaging process in a way that the dimension in the second direction after folded is smaller as possible; on the other hand, since the dimension in the first direction is much smaller than that in the second direction, the antenna 200 will be able to form a compact elongated structure after completely folded, which will significantly reduce the dimension in the first direction. The above two aspects both will significantly reduce the space occupied by the antenna 200 inside the packaging container 100, so that the packaging container 100 and its inner cavity dimensions can be designed to be smaller both in the first direction and in the second direction, which is very advantageous for saving space for transportation and storage, as well as for reducing the cost of packaging. In addition, folding compactly can also improve the impact strength of the antenna 200 during transportation and storage, which is more conducive to avoiding damage or deformation due to external forces during transportation and storage, and protecting the flexible substrate 210 and the antenna element 220 of the antenna 200.

The dimension of the elongated structure in the first direction is preferably in the range of 1.5 to 8 cm, so that the antenna 200 has a moderate and stable dimension after folded into the elongated structure. Such a dimension design is neither too large to cause the packaging container 100 to be too bulky, nor too small to affect the performance or structural integrity of the antenna 200. This moderate dimension design helps to achieve standardization and uniformity of the packaging container 100, and facilitates production, transportation and management. During the folding process, the moderate dimension in the first direction ensures a stable relative position between the components of the antenna 200 and avoids displacement or deformation due to vibration or impact during transportation. This helps protect structural integrity of the antenna 200 and ensures that it can work properly after unfolded. After folding is completed, the moderate dimension in the first direction also makes the packaging container 100 moderate in dimensions, which is convenient for sales transportation and storage, as well as convenient for the user to carry and move. For users, whether working outdoors or using indoors, it can be easily carried to meet his communication needs anytime and anywhere.

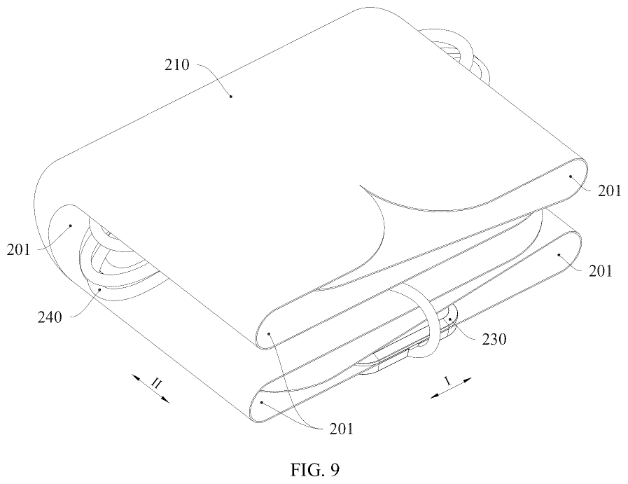

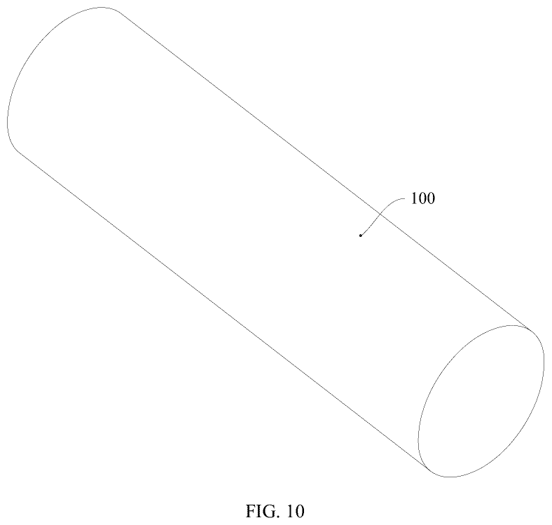

The flexible substrate 210 can be folded several times in the first direction and then further folded several times in the second direction perpendicular to the first direction, as shown in FIG. 9, in such way the antenna 200 can be compressed into a more compact form, which significantly reduces the volume occupied in the packaging, which is conducive to reducing the dimensions of the packaging container 100 and its inner cavity, and makes the entire packaging structure of the antenna 200 more compact and lightweight. This not only reduces the cost of packaging, but also makes transportation and storage more convenient, and is particularly suitable for scenarios with limited space. In the folding process, whether folding in the first direction or in the second direction, if folded at least two times in that direction, it is preferred to fold it in the wallet-folding manner, which makes full use of the elastic space 201 formed by each folding, and makes the folded antenna 200 more compact. After being folded, the antenna 200 as a whole presents a wallet-like structure, referred to as a wallet-like structure, and can be packaged in a flat packaging container 100, so that the antenna 200 presents a neat and organized appearance after packaging, which enhances the overall texture of the product. The coaxial cable 240 may be disposed between the wallet-like structure and the packaging container 100, or may be disposed in the elastic space 201. The latter can fully utilize the elastic space 201 and hold up the elastic space 201 to avoid the elastic space 201 from being overly squeezed by an external force, thereby avoiding the electrical performance of the antenna element 220 from being affected. Specifically, it can be disposed in the elastic space 201 formed by folding in the second direction.

The feeder structure 230 may be disposed in the middle of the flexible substrate 210 in the first direction, as shown in FIG. 4, or in the middle of the flexible substrate 210 in the second direction, and may also be disposed in the middle of the flexible substrate 210 in the first direction and the second direction, as shown in FIG. 3. In the process of folding into the above wallet-like structure shown in FIG. 9, the flexible substrate 210 is folded even number of times in the corresponding direction, so that the folding lines are evenly distributed on the both sides of the feeder structure 230, which makes the folding lines avoiding the feeder structure 230, thus avoiding the need to repeatedly adjust position of the folding line during folding process to improve folding efficiency. The even number of folding also ensures that the flexible substrate 210 can form a symmetrical structure after being folded, thus making the antenna 200 more neat and organized in appearance. Additionally, this folding method also effectively reduces the space occupied by the antenna 200 in the package and improves space utilization rate.

The dimension of the wallet-like structure in a third direction perpendicular to the first direction and the second direction may be set to 2 to 6 cm, and the dimension thereof in the first direction and/or the second direction may be set to 5 to 15 cm, so that the antenna 200 has a moderate and stable dimension after being folded into the wallet-like structure. Such a dimension design is neither too large to cause the packaging container 100 to be too large, nor too small to affect the performance or structural integrity of the antenna 200. This moderate dimension design helps to achieve standardization and uniformity of the packaging container 100, and facilitates production, transportation, and management. During the folding process, the moderate dimension in the third direction ensures that the elastic space 201 is not excessively squeezed, which helps protect structural integrity of the antenna 200 and ensures that it can work properly after being unfolded. After the folding is completed, the moderate dimension in the third direction also allows the packaging container 100 of moderate dimension, which is convenient for sales transportation and storage, as well as convenient for users to carry and move. For users, whether working outdoors or using indoors, it can be easily carried to meet his communication needs anytime and anywhere.

The flexible substrate 210 may be a sheet-like structure made of thermoplastic polyurethane elastomer (TPU), polyimide (PI), or polyester (PET, etc.). The flexible substrate 210 made of such material can give the antenna 200 excellent flexibility and crease resistance. This material is not only lightweight, but also capable of maintaining its structural integrity and not easily damaged when subjected to external forces. This enables the antenna 200 to maintain its original functionality and stability in scenarios where bending is required.

The antenna element 220 may be a metal conductive network layer printed on the flexible substrate 210, which not only simplifies the manufacturing process of the antenna 200 and reduces the production cost, but also improves integration degree of the antenna 200, precision and reliability of the antenna element 220, and also enhances bonding force of the antenna element 220 with the flexible substrate 210 to avoid risk of damage caused by folding. In addition, the metal conductive network layer has excellent conductive properties, which ensures high efficiency and stability of the antenna element 220 in the signal transmission process.

With fully taking into account the balance between performance of the antenna 200 and difficulty of manufacturing, the linewidth of each line in the antenna element 220 may be set to 3 to 12 mm. The relatively wide linewidth is conducive to lowering resistance and improving radiation efficiency of the antenna 200, and this linewidth range is also within capability of existing manufacturing technology, which thus can realize relatively high manufacturing precision and consistency.

Obviously, the above embodiments of the present disclosure are merely examples for the purpose of clearly illustrating the present disclosure, and are not intended to be a limitation of the manner of implementation of the present disclosure. To a person of ordinary skill in the art, other variations or changes in different forms may be made on the basis of the above description. It is neither necessary nor possible to exhaust all of the embodiments herein. Any modifications, equivalent substitutions and improvements made within the spirit and principles of the present disclosure shall be included in the scope of protection of the claims of the present disclosure.

What is claimed is:

1. An antenna packaging structure, comprising a packaging container and an antenna contained in the packaging container, the antenna comprising a flexible substrate, an antenna element disposed on the flexible substrate, a feeder structure connected to the antenna element, and a coaxial cable connected to the feeder structure,
wherein inside the packaging container, the flexible substrate is in a folded state with at least one folding line thereof avoiding the feeder structure, and an elastic space with a teardrop-shaped cross-section is formed between the flexible substrate on both sides of the at least one folding line in each folding; the antenna element is folded along with the flexible substrate and maintains electrical properties after being unfolded; the coaxial cable is disposed within the elastic space or between the flexible substrate and the packaging container.

2. The antenna packaging structure according to claim 1, wherein a dimension of a cavity of the packaging container matches a dimension of the flexible substrate after being folded.

3. The antenna packaging structure according to claim 1, wherein the flexible substrate has a first direction and a second direction perpendicular to each other, the flexible substrate is folded at least two times in the first direction to form an elongated structure, and edges of two sides of the elongated structure parallel to the second direction are respectively close to edges of two sides of the feeder structure.

4. The antenna packaging structure according to claim 3, wherein the feeder structure is disposed in a middle of the flexible substrate in the first direction, dividing the flexible substrate into a left substrate and a right substrate, the left substrate being folded to the right along an edge of the feeder structure, and the right substrate, together with the left substrate covering thereon, continuing to be folded to the right multiple times along the edge of the feeder structure to form the elongated structure; or
wherein the feeder structure is disposed in a middle of the flexible substrate in the first direction, dividing the flexible substrate into a left substrate and a right substrate, the right substrate being folded to the left along an edge of the feeder structure, and the left substrate, together with the right substrate covering thereon, continuing to be folded to the left multiple times along the edge of the feeder structure to form the elongated structure.

5. The antenna packaging structure according to claim 3, wherein the feeder structure is disposed in a middle of the flexible substrate in the first direction, dividing the flexible substrate into a left substrate and a right substrate, the left substrate being folded to the right along an edge of one side of the feeder structure, and the right substrate being folded to the left multiple times together with the left substrate covering thereon, and finally being folded along an edge of the other side of the feeder structure to form the elongated structure; or
wherein the feeder structure is disposed in a middle of the flexible substrate in the first direction, dividing the flexible substrate into a left substrate and a right substrate, the right substrate being folded to the left along an edge of one side of the feeder structure, the left substrate being folded to the right multiple times together with the right substrate covering thereon, and finally being folded along an edge of the other side of the feeder structure to form the elongated structure.

6. The antenna packaging structure according to claim 3, wherein a dimension of the elongated structure in the second direction is 3 to 15 times a dimension thereof in the first direction, and the dimension of the elongated structure in the first direction is 1.5 to 8 cm.

7. The antenna packaging structure according to claim 1, wherein the flexible substrate has a first direction and a second direction perpendicular to each other, the flexible substrate is folded at least one time in the first direction and then folded at least one time in the second direction to form a wallet-like structure.

8. The antenna packaging structure according to claim 7, wherein the feeder structure is disposed in a middle of the flexible substrate in the first direction, the flexible substrate being folded even number of times in the first direction; and/or
wherein the feeder structure is disposed in a middle of the flexible substrate in the second direction, the flexible substrate being folded even number of times in the second direction.

9. The antenna packaging structure according to claim 7, wherein the wallet-like structure has a third direction perpendicular to the first direction and the second direction, which has a dimension of 2 to 6 cm in the third direction and a dimension of 5 to 15 cm in the first direction and/or the second direction.

10. The antenna packaging structure according to claim 1, wherein the flexible substrate is a sheet-like structure made of thermoplastic polyurethane elastomer, polyimide or polyester.

11. The antenna packaging structure according to claim 1, wherein the antenna element is a metallic conductive network layer printed on the flexible substrate.

12. The antenna packaging structure according to claim 1, wherein a linewidth of each line in the antenna element is 3 to 12 mm.
